(19) United States
(12) Patent Application Publication
(10) Pub. No.: US 2024/0426225 A1
(43) Pub. Date: Dec. 26, 2024

(54) ELECTRICAL ACTUATION OF VARIABLE STATOR VANES

(71) Applicant: Hamilton Sundstrand Corporation, Charlotte, NC (US)

(72) Inventors: Ryan Shook, Loves Park, IL (US); Ryan Prescott Susca, Windsor, CT (US)

(73) Assignee: Hamilton Sundstrand Corporation, Charlotte, NC (US)

(21) Appl. No.: 18/214,064

(22) Filed: Jun. 26, 2023

(51) Int. Cl. F01D 17/16; F01D 9/04

(52) U.S. Cl. CPC F01D 17/162; F01D 9/041; F05D 2260/74; F05D 2260/79; F05D 2270/62

(57) ABSTRACT

A system for vane pitch actuation includes an electric motor with a rotary output shaft defining a drive axis. A worm shaft defines a drive axis, and is operatively connected to be driven in rotation about the drive axis by the rotary output shaft of the electric motor. A sync ring is defined about an engine axis that is orthogonal to the drive axis. The sync ring is configured to rotate about the engine axis over a range of positions for driving a plurality of variable pitch stator vanes to each have a pitch based on position of the sync ring. The sync ring includes a plurality of gear teeth for actuation of the sync ring by the electric motor.

### BACKGROUND

### 1. Field

The present disclosure relates to variable pitch stator vanes, and more particularly to actuation of variable pitch stator vanes in gas turbine engines.

### 2. Description of Related Art

Fans, Compressor sections, and turbine sections in gas turbine engines can include variable pitch stator vanes. Variable pitch stator vanes are actuated to adapt an engine to the various engine operating conditions for power and efficiency. Traditional stator actuation schemes are hydraulic, e.g. using fuel from the fuel system as the hydraulic fluid, comprising a high-pressure pump, lines, and hydraulic cylinder type actuators that act on a sync ring to move all actuators of a stage. The traditional actuators are controlled with feedback loops using position feedback, pressure, and engine speed. These systems (the pump) can be mechanically driven from the turbine of the engine and have constant parasitic power draw from the engine to function, i.e. even when the variable pitch stator vanes are stationary.

The conventional techniques have been considered satisfactory for their intended purpose. However, there is an ever present need for improved systems and methods for actuating variable pitch stator vanes. This disclosure provides a solution for this need.

### SUMMARY

A system for vane pitch actuation includes an electric motor with a rotary output shaft defining a drive axis. A worm shaft as aligned with the drive axis, and is operatively connected to be driven in rotation about the drive axis by the rotary output shaft of the electric motor. A sync ring is defined about an engine axis that is orthogonal to the drive axis. The sync ring is configured to rotate about the engine axis over a range of positions for driving a plurality of variable pitch stator vanes to each have a pitch based on position of the sync ring. The sync ring includes a plurality of worm wheel gear teeth engaged to one or more worm gear teeth of the worm shaft for actuation of the sync ring by the electric motor.

The worm wheel gear teeth can be defined on a forward facing surface of the sync ring relative to the engine axis. The worm wheel gear teeth can be defined on an aft facing surface of the sync ring relative to the engine axis. The worm wheel gear teeth can be defined on a radially outward facing surface of the sync ring relative to the engine axis.

A plurality of vane linkages can be connected to the sync ring, each for rotating pitch of one of the plurality of variable pitch stator vanes. The plurality of variable pitch stator vanes can be each operatively connected to a respective one of the plurality of vane linkages for rotating pitch.

The gas turbine engine can be included, defined along the engine axis. The gas turbine engine can include an inner case defining a gas path, wherein the plurality of variable pitch stator vanes are inside the inner case, in the gas path. The worm wheel gear teeth and the one or more worm gear teeth can be outside of the inner case but inside an outer case of the gas turbine engine. The electric motor can be outside the outer case. At least one of the rotary output shaft and/or the worm shaft can extend through the outer case. The worm shaft can be oriented tangent to the sync ring.

A position resolver can be operatively connected to at least one of the rotary shaft, to the sync ring, and/or to the worm shaft to generate feedback indicative of position of the sync ring. A controller can be operatively connected to receive the feedback indicative of position and to control the electric motor based on the feedback.

A system for vane pitch actuation includes an electric motor with a rotary output shaft defining a drive axis. A pinion is aligned with the drive axis, and is operatively connected to be driven in rotation about the drive axis by the rotary output shaft of the electric motor. A sync ring is defined about an engine axis that is orthogonal to the drive axis. The sync ring is configured to rotate about the engine axis over a range of positions for driving a plurality of variable pitch stator vanes to each have a pitch based on position of the sync ring. The sync ring includes a plurality of rack gear teeth engaged to one or more pinion gear teeth of the pinion for actuation of the sync ring by the electric motor.

The rack gear teeth can be defined on a forward facing surface of the sync ring relative to the engine axis. The rack gear teeth can be defined on an aft facing surface of the sync ring relative to the engine axis. The rack gear teeth can be defined on a radially outward facing surface of the sync ring relative to the engine axis.

A plurality of vane linkages can be connected to the sync ring, each for rotating pitch of one of the plurality of variable pitch stator vanes. The plurality of variable pitch stator vanes can be each operatively connected to a respective one of the plurality of vane linkages for rotating pitch.

The gas turbine engine can be included, defined along the engine axis. The gas turbine engine can include an inner case defining a gas path, wherein the plurality of variable pitch stator vanes are inside the inner case, in the gas path. The rack gear teeth and the one or more pinion gear teeth can be outside of the inner case but inside an outer case of the gas turbine engine. The electric motor can be outside the outer case. The rotary output shaft can extend through the outer case. The pinion can be oriented radial to the sync ring.

A position resolver can be operatively connected to at least one of the rotary shaft, to the sync ring, and/or to the pinion to generate feedback indicative of position of the sync ring. A controller can be operatively connected to receive the feedback indicative of position and to control the electric motor based on the feedback.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic perspective view of an embodiment of a vane actuation system constructed in accordance with the present disclosure, showing a worm gear configuration for driving the vane actuation electrically;

FIG. 2 is a schematic axial end elevation view of a portion of the system of FIG. 1, showing the tangential arrangement of the sync ring and the worm shaft;

FIG. 3 is a is a schematic perspective view of an embodiment of a vane actuation system constructed in accordance with the present disclosure, showing a rack and pinion configuration for driving the vane actuation electrically; and

FIG. 4 schematic axial end elevation view of a portion of the system of FIG. 3, showing the radial arrangement of the pinion relative to the sync ring.

### DETAILED DESCRIPTION OF THE PREFERRED EMBODIMENTS

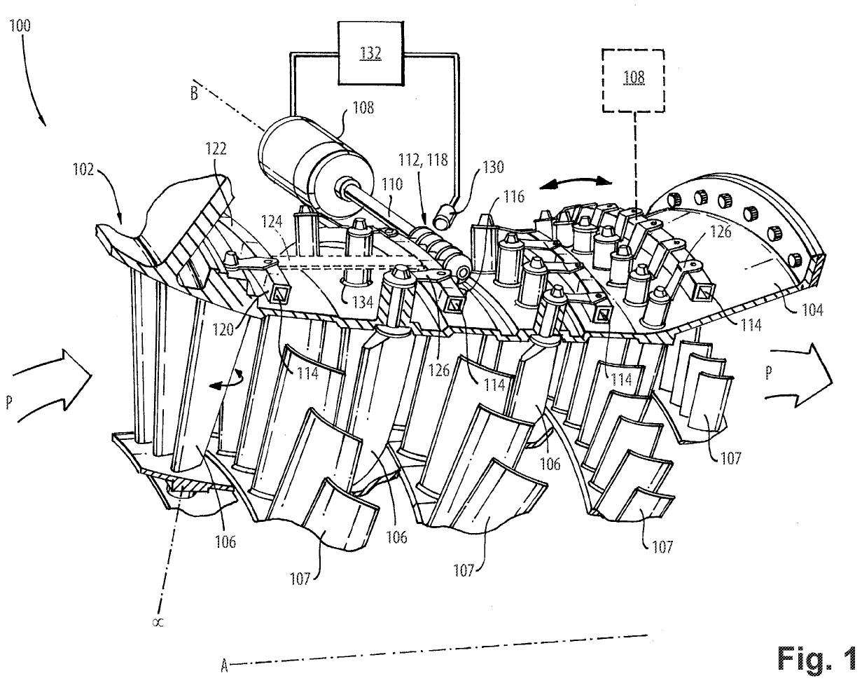

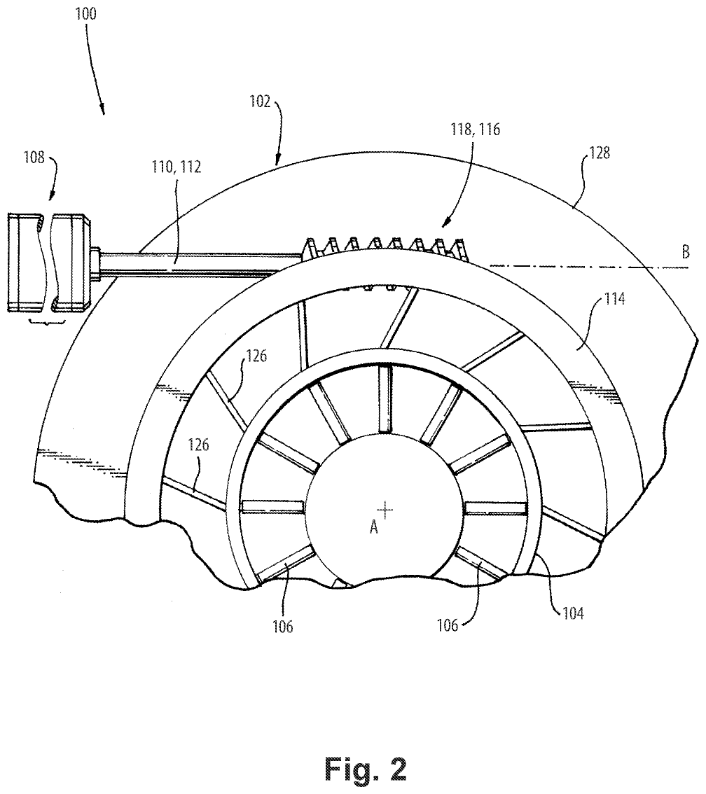

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. Other embodiments of systems in accordance with the disclosure, or aspects thereof, are provided in FIGS. 2-4, as will be described. The systems and methods described herein can be used to electrically actuate variable pitch vanes, e.g. to reduce power needed to run hydraulic actuation systems that traditionally drive van actuation.

The gas turbine engine 102 is defined along the engine axis A. The gas turbine engine 102 includes an inner case 104 defining a gas path P. A plurality of variable pitch stator vanes 106, e.g. in the fan, turbine section, or compressor section of the gas turbine engine 102, are inside the inner case 104, in the gas path P. The rotor vanes 107 alternate with the stator vanes 106 in the longitudinal direction along the engine axis A. Each variable pitch stator vane 106 can change its angle of attack in the gas path P by rotation about its radial axis a. The system 100 for vane pitch actuation includes an electric motor 108 with a rotary output shaft 110 defining a drive axis B. A worm shaft 112 is aligned on the drive axis B, and is operatively connected to be driven in rotation about the drive axis B by the rotary output shaft 110 of the electric motor 108. A sync ring 114 is defined about the engine axis that is orthogonal to the drive axis. The sync ring 114 is configured to rotate about the engine axis A over a range of positions, schematically indicated in FIG. 1 by the large double headed arrow, for driving a plurality of the variable pitch stator vanes 106 to each have a pitch based on position of their sync ring 114. The sync ring 114 includes a plurality of worm wheel gear teeth 116 engaged to one or more worm gear teeth 118 of the worm shaft for actuation of the sync ring 114 by the electric motor 108. The worm wheel gear teeth 118 can be defined on a forward facing surface 120 of the sync ring 114, on an aft facing surface 122 of the sync ring 114, or on the radially outward facing surface 124 of the sync ring 114 relative to the engine axis A.

A plurality of vane linkages 126 are connected to the sync ring 114, each for rotating pitch of one of the variable pitch stator vanes 106. The variable pitch stator vanes 106 are each operatively connected to a respective one of the plurality of vane linkages 126 for rotating pitch.

With reference now to FIG. 2, the worm wheel gear teeth 116 and the one or more worm gear teeth 118 are outside of the inner case 104 but inside an outer case 128 of the gas turbine engine 102. The electric motor 108 is outside the outer case 128. At least one of the rotary output shaft 110 and/or the worm shaft 112 extend through the outer case 128. The worm shaft 112, and its rotation axis B, is oriented tangent to the sync ring 114, which is defined around the engine axis A.

With reference again to FIG. 1, a position resolver 130 is operatively connected to at least one of the rotary shaft 110, to the sync ring 114, and/or to the worm shaft 112 to generate feedback indicative of position of the sync ring 114. A controller 132 is operatively connected to receive the feedback indicative of position and to control the electric motor 108 based on the feedback. Although in FIG. 1, there is only one sync ring 114 connected to the motor 108, those skilled in the art will readily appreciate that each sync ring 114 can have its own motor 108 (one of which is indicated in FIG. 1 with broken lines) so all of the sync rings 114 can be individually actuated, or each sync ring can be connected by a linkage 134 (one of which is indicated in FIG. 1 with broken lines) to the one sync ring 114 that is directly connected to the motor 108 so that all of the sync rings 104 can be actuated together.

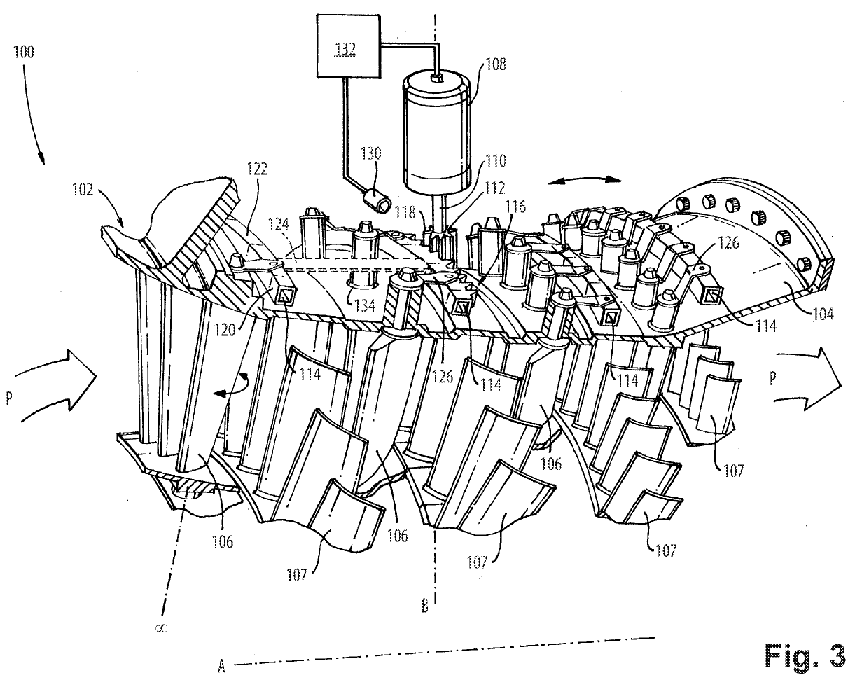

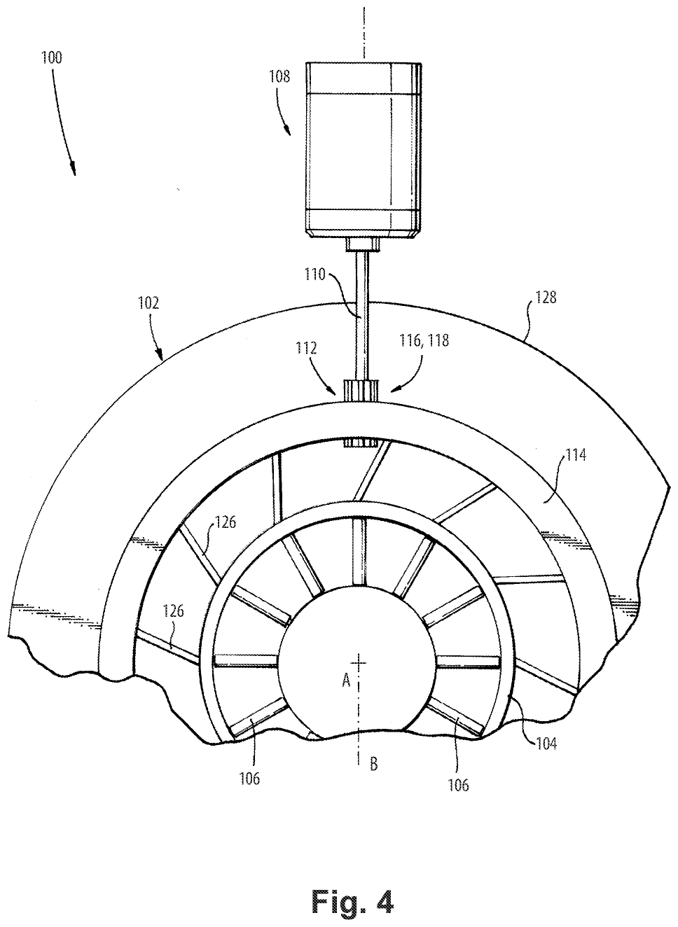

With reference now to FIG. 3, a similar system 100 for vane pitch actuation includes an electric motor 108 with a rotary output shaft 110 defining a drive axis B. A pinion 112 defines a drive axis B, and is operatively connected to be driven in rotation about the drive axis B by the rotary output shaft 110 of the electric motor 108. A sync ring 114 is defined about an engine axis A as described above for adjusting angle of attack of a plurality of variable pitch stator vanes 114. The sync ring 114 includes a plurality of rack gear teeth 116 engaged to one or more pinion gear teeth 118 of the pinion 112 for actuation of the sync ring 114 by the electric motor 108. The rack gear teeth 118 can be defined on the forward, aft, or radially outward facing surfaces 120, 124, 122 of the sync ring 114 as long as they mesh with the pinion 112, much as described above with respect to FIGS. 1-2. Other aspects of the system 100 in FIG. 3 that are the same as already described above with respect to FIGS. 1-2 will not be repeated, but like reference numbers are used in FIGS. 3-4 for like components.

With reference to FIG. 4, the rack and pinion configuration of the system 100 is shown in elevation. The rack gear teeth 116 and the one or more pinion gear teeth 118 are outside of the inner case 104 but inside the outer case 128 of the gas turbine engine 102. The electric motor 108 is outside the outer case 128. The rotary output 110 shaft a extends through the outer case 128. The pinion 112, by virtue of rotating about the drive axis B, is oriented radial to the sync ring 114 instead of tangent as in the worm drive configuration of FIG. 2.

Systems and methods as disclosed herein provide potential benefits including the following. They can remove or substantially reduce the size of the fuel system hydraulic needs of engine actuation system over traditional hydraulically driven sync ring systems. They allow for reduced mechanical part count, reduced envelope, and reduced weight of the vane actuation system compared to more traditional configurations. They can provide for zero parasitic power consumption, e.g., when utilizing non-backfeeding gears. They can also provide improved positional accuracy and reduced hysteresis. In traditional variable pitch actuation, there is an actuator that drives a drive link, that drives a torque box, that drives a drive link, that drives the sync ring, which drives the vane arm. However, with systems and methods as disclosed herein, the number of pinned/bolted joints is reduced, reducing the overall slop in the linkage, which improves accuracy and reduces hysteresis relative to the traditional configurations.

The methods and systems of the present disclosure, as described above and shown in the drawings, provide for electrical actuation of variable pitch vanes, e.g. to reduce power needed to run hydraulic actuation systems that traditionally drive van actuation. While the apparatus and methods of the subject disclosure have been shown and described with reference to preferred embodiments, those skilled in the art will readily appreciate that changes and/or modifications may be made thereto without departing from the scope of the subject disclosure.

1. A system for vane pitch actuation for a gas turbine engine, the system comprising:
an inner case defining a gas path;
an outer case radially outward relative to the inner case;
an electric motor with a rotary output shaft defining a drive axis;
a worm shaft aligned with the drive axis, operatively connected to be driven in rotation about the drive axis by the rotary output shaft of the electric motor; and
a sync ring defined about an engine axis that is orthogonal to the drive axis, wherein the sync ring is configured to rotate about the engine axis over a range of positions for driving a plurality of variable pitch stator vanes to each have a pitch based on position of the sync ring, and wherein the sync ring includes a plurality of worm wheel gear teeth engaged to one or more worm gear teeth of the worm shaft for actuation of the sync ring by the electric motor;
wherein the worm wheel gear teeth and the one or more worm gear teeth of the worm shaft are outside of the inner case but inside the outer case of the gas turbine engine, and wherein the electric motor is outside the outer case, and wherein at least one of the rotary output shaft and/or the worm shaft extend through the outer case.

2. (canceled)

3. The system as recited in claim 1, wherein the worm wheel gear teeth are defined on an aft facing surface of the sync ring relative to the engine axis.

4. (canceled)

5. The system as recited in claim 1, further comprising a plurality of vane linkages connected to the sync ring, each for rotating pitch of one of the plurality of variable pitch stator vanes.

6. The system as recited in claim 5, further comprising the plurality of variable pitch stator vanes, each operatively connected to a respective one of the plurality of vane linkages for rotating pitch.

7. The system as recited in claim 6, wherein the plurality of variable pitch stator vanes are inside the inner case, in the gas path.

8. (canceled)

9. The system as recited in claim 1, wherein the worm shaft is oriented tangent to the sync ring.

10. The system as recited in claim 1, further comprising a position resolver operatively connected to at least one of the rotary shaft, to the sync ring, and/or to the worm shaft to generate feedback indicative of position of the sync ring; and a controller operatively connected to receive the feedback indicative of position and to control the electric motor based on the feedback.

11-20. (canceled)

21. A system for vane pitch actuation for a gas turbine engine, the system comprising:
an inner case defining a gas path;
an outer case radially outward relative to the inner case;
an electric motor with a rotary output shaft defining a drive axis;
a worm shaft aligned with the drive axis, operatively connected to be driven in rotation about the drive axis by the rotary output shaft of the electric motor; and
a sync ring defined about an engine axis that is orthogonal to the drive axis, wherein the sync ring is configured to rotate about the engine axis over a range of positions for driving a plurality of variable pitch stator vanes to each have a pitch based on position of the sync ring, and wherein the sync ring includes a plurality of worm wheel gear teeth engaged to one or more worm gear teeth of the worm shaft for actuation of the sync ring by the electric motor;
wherein the worm wheel gear teeth and the one or more worm gear teeth of the worm shaft are outside of the inner case but inside the outer case of the gas turbine engine, and wherein the electric motor is outside the outer case, and wherein at least one of the rotary output shaft and/or the worm shaft extend through the outer case, wherein the worm wheel gear teeth are defined on an aft facing surface of the sync ring relative to the engine axis, and wherein the worm shaft is oriented tangent to the sync ring.

22. The system as recited in claim 21, further comprising a plurality of vane linkages connected to the sync ring, each for rotating pitch of one of the plurality of variable pitch stator vanes.

23. The system as recited in claim 22, further comprising the plurality of variable pitch stator vanes, each operatively connected to a respective one of the plurality of vane linkages for rotating pitch.

24. The system as recited in claim 23, wherein the plurality of variable pitch stator vanes are inside the inner case, in the gas path.

25. The system as recited in claim 21, further comprising a position resolver operatively connected to at least one of the rotary shaft, to the sync ring, and/or to the worm shaft to generate feedback indicative of position of the sync ring; and a controller operatively connected to receive the feedback indicative of position and to control the electric motor based on the feedback.

26. A system for vane pitch actuation for a gas turbine engine, the system comprising:
an inner case defining a gas path;
an outer case radially outward relative to the inner case;
an electric motor with a rotary output shaft defining a drive axis;
a worm shaft aligned with the drive axis, operatively connected to be driven in rotation about the drive axis by the rotary output shaft of the electric motor;
a sync ring defined about an engine axis that is orthogonal to the drive axis, wherein the sync ring is configured to rotate about the engine axis over a range of positions for driving a plurality of variable pitch stator vanes to each have a pitch based on position of the sync ring, and wherein the sync ring includes a plurality of worm wheel gear teeth engaged to one or more worm gear teeth of the worm shaft for actuation of the sync ring by the electric motor; and
a position resolver operatively connected to at least one of the rotary shaft, to the sync ring, and/or to the worm shaft to generate feedback indicative of position of the sync ring; and a controller operatively connected to receive the feedback indicative of position and to control the electric motor based on the feedback;
wherein the worm wheel gear teeth and the one or more worm gear teeth of the worm shaft are outside of the inner case but inside the outer case of the gas turbine engine, and wherein the electric motor is outside the outer case, and wherein at least one of the rotary output shaft and/or the worm shaft extend through the outer case, and wherein the worm wheel gear teeth are defined on an aft facing surface of the sync ring relative to the engine axis.

27. The system as recited in claim 26, further comprising a plurality of vane linkages connected to the sync ring, each for rotating pitch of one of the plurality of variable pitch stator vanes.

28. The system as recited in claim 27, further comprising the plurality of variable pitch stator vanes, each operatively connected to a respective one of the plurality of vane linkages for rotating pitch.

29. The system as recited in claim 28, wherein the plurality of variable pitch stator vanes are inside the inner case, in the gas path.
